(19) United States
(12) Patent Application Publication
(10) Pub. No.: US 2010/0235448 A1
(43) Pub. Date: Sep. 16, 2010

(54) Methods, Systems, And Computer Program Products For Reporting A Change In Presentable Content Of A Communication Message

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/402,965

(22) Filed: Mar. 12, 2009

(51) Int. Cl. G06F 15/16

(52) U.S. Cl. 709/206

(57) ABSTRACT

Methods and systems are described for reporting a change in presentable content of a communication message. In one aspect, an indication is received that presentable content transported via a communication message is changed along a network path traversed by the communication message. The indication is received by a network node outside the network path from a node along the network path. Responsive to the received indication, a change message indicating the change to the presentable content of the communication message is generated. The generated change message is transmitted separately from the communication message to a node along the network path.

### BACKGROUND

Many communication messages, such as e-mail, text messages, multimedia messages, and the like, transmitted over a network from a sending node include some form of content that can be presented at a receiving node. Presentable content, such as text, images, video, audio, and the like, transmitted via the communication message is often changed after transmission from the sending node. For example, changes to the presentable content can occur at an intermediate node while the communication message is in route or can occur at the destination node. Currently, reporting such presentable content changes to interested parties requires a user to determine that a change has occurred and initiate some sort of reporting, e.g., by sending another communication message.

Accordingly, there exists a need for methods, systems, and computer program products for reporting a change in presentable content of a communication message.

### SUMMARY

Methods and systems are described for reporting a change in presentable content of a communication message. In one aspect, an indication is received that presentable content transported via a communication message is changed along a network path traversed by the communication message. The indication is received by a network node outside the network path from a node along the network path. Responsive to the received indication, a change message indicating the change to the communication message is generated. The generated change message is transmitted separately from the communication message to a node along the network path.

In another aspect, a change message is received from a network node outside a network path traversed by a communication message. Change information indicating whether presentable content transported via the communication message changed along the network path traversed by the communication message is determined based on the received change message. An action to be performed is determined based on the change information. Performing the determined action is provided for.

In another aspect, a system for reporting a change in presentable content of a communication message includes means for receiving an indication that presentable content transported via a communication message is changed along a network path traversed by the communication message, the indication being received by a network node outside the network path from a node along the network path; Means for generating, responsive to the received indication, a change message indicating the change to the presentable content of the communication message; and means for transmitting, separately from the communication message, the generated change message to a node along the network path. At least one of the means includes at least one electronic hardware component.

In another aspect, a system for reporting a change in presentable content of a communication message includes system components including a change detector component configured to receive an indication that presentable content transported via a communication message is changed along a network path traversed by the communication message, the indication being received by a network node outside the network path from a node along the network path; a notification handler component configured to generate, responsive to the received indication, a change message indicating the change to the presentable content of the communication message; and a message router component configured to transmit, separately from the communication message, the generated change message to a node along the network path. At least one of the system components includes at least one electronic hardware component.

In another aspect, a system for reporting a change in presentable content of a communication message includes means for receiving a change message from a network node outside a network path traversed by a communication message; means for determining, based on the received change message, change information indicating whether presentable content transported via the communication message changed along the network path traversed by the communication message; and means for determining an action to be performed based on the change information. At least one of the means includes at least one electronic hardware component.

In another aspect, a system for reporting a change in presentable content of a communication message includes system components including a change message handler component configured to receive a change message from a network node outside a network path traversed by a communication message, and to determine, based on the received change message, change information indicating whether presentable content transported via the communication message changed along the network path traversed by the communication message; a controller component configured to determine an action to be performed based on the change information; and an action handler component configured to provide for performing the determined action. At least one of the system components includes at least one electronic hardware component.

In another aspect, a computer readable medium storing a computer program, executable by a machine, for reporting a change in presentable content of a communication message is discussed. The computer program includes executable instructions for receiving an indication that presentable content transported via a communication message is changed along a network path traversed by the communication message, the indication being received by a network node outside the network path from a node along the network path; generating, responsive to the received indication, a change message indicating the change to the presentable content of the communication message; and transmitting, separately from the communication message, the generated change message to a node along the network path.

In another aspect, a computer readable medium storing a computer program, executable by a machine, for reporting a change in presentable content of a communication message is discussed. The computer program includes executable instructions for receiving a change message from a network node outside a network path traversed by a communication message; determining, based on the received change message, change information indicating whether presentable content transported via the communication message changed along the network path traversed by the communication message; and determining an action to be performed based on the change information. providing for performing the determined action.

### BRIEF DESCRIPTION OF THE DRAWINGS

Advantages of the subject matter described will become apparent to those skilled in the art upon reading this description in conjunction with the accompanying drawings, in which like reference numerals have been used to designate like or analogous elements, and in which:

FIG. 1 is a flow diagram illustrating a method for reporting a change in presentable content of a communication message according to an aspect of the subject matter described herein;

FIG. 2 is block a diagram illustrating a system for reporting a change in presentable content of a communication message according to another aspect of the subject matter described herein;

FIG. 3 is a block diagram illustrating the components of the system of FIG. 2 operating in an execution environment hosted by one or more network nodes according to an exemplary aspect of the subject matter described herein;

FIG. 4 is a block diagram showing an exemplary arrangement of nodes in a network environment with messaging according to an exemplary aspect of the subject matter described herein;

FIG. 5 is a flow diagram illustrating a method for reporting a change in presentable content of a communication message according to another aspect of the subject matter described herein;

FIG. 6 is block a diagram illustrating a system for reporting a change in presentable content of a communication message according to another aspect of the subject matter described herein;

FIG. 7 is a block diagram illustrating the components of the system of FIG. 2 and the system of FIG. 6 operating in an execution environment hosted by one or more network nodes according to an exemplary aspect of the subject matter described herein;

FIG. 8 is a block diagram illustrating the components of the system of FIG. 2 and the system of FIG. 6 operating in an execution environment hosted by one or more network nodes according to an exemplary aspect of the subject matter described herein; and

FIG. 9 is a block diagram illustrating an exemplary hardware device in which the subject matter described herein may be implemented.

### DETAILED DESCRIPTION

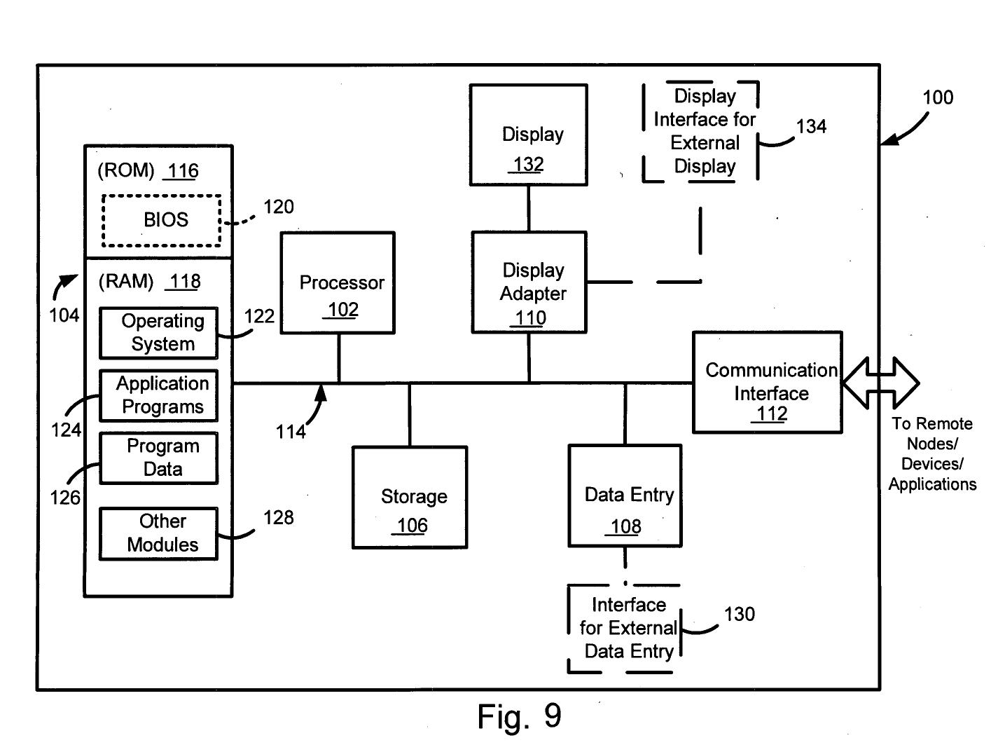

Prior to describing the subject matter in detail, an exemplary hardware device in which the subject matter may be implemented shall first be described. Those of ordinary skill in the art will appreciate that the elements illustrated in FIG. 9 may vary depending on the system implementation. With reference to FIG. 9, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 9 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 9. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

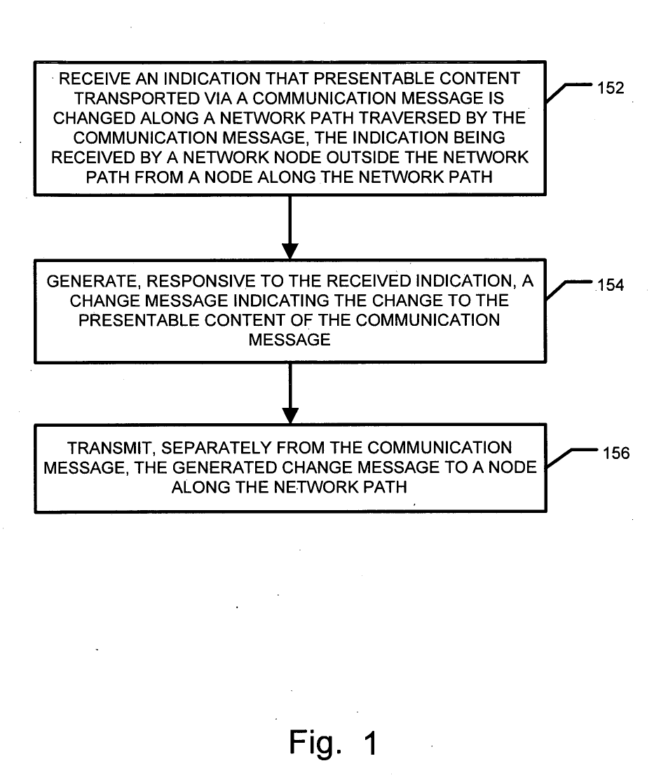

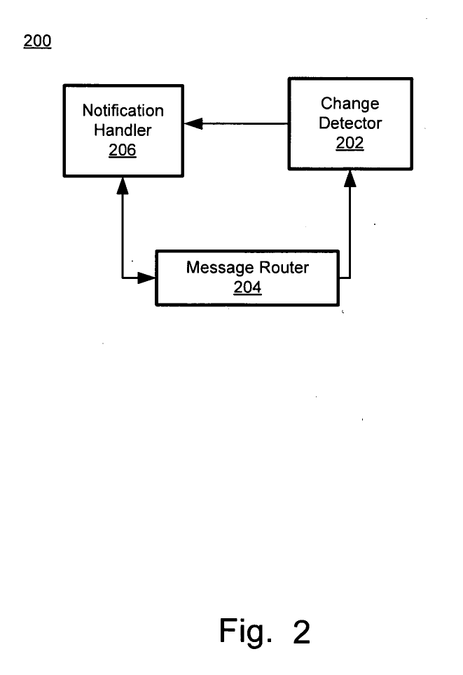

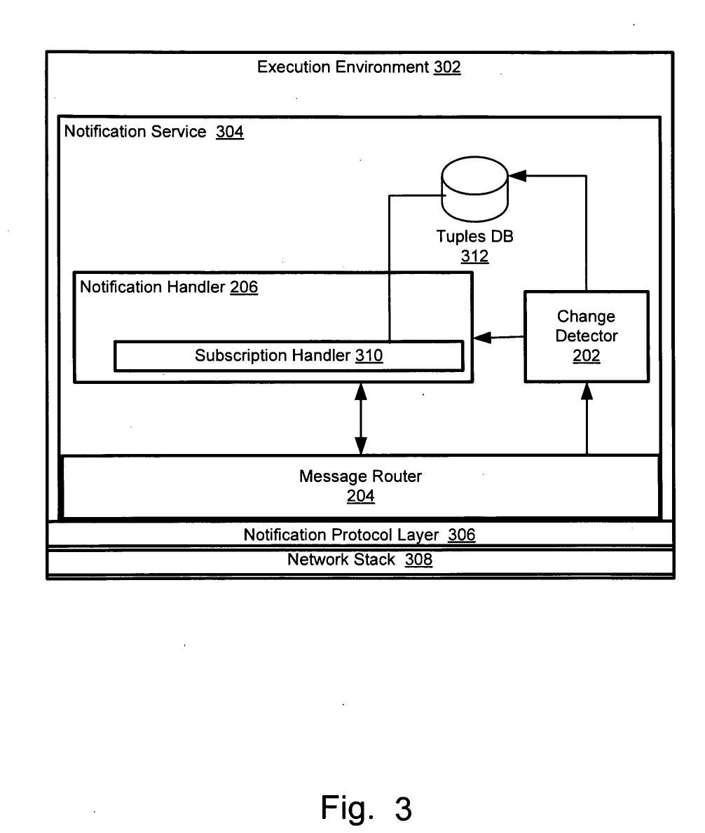

FIG. 1 is a flow diagram illustrating a method for reporting a change in presentable content of a communication message according to an exemplary aspect of the subject matter described herein. FIG. 2 is a block diagram illustrating a system 200 for reporting a change in presentable content of a communication message according to an exemplary aspect of the subject matter described herein. FIG. 3 is a block diagram illustrating the components of FIG. 2 operating in an execution environment 302 hosted by a network node or a plurality of network nodes according to an exemplary aspect of the subject matter described herein. The method illustrated in FIG. 1 can be carried out by, for example, some or all of the components illustrated in FIGS. 2 and 3.

The execution environment 302 illustrated in FIG. 3 can be hosted by one or multiple network nodes, as in a distributed execution environment, and is adapted for supporting the system components illustrated in FIG. 2. An exemplary execution environment 302 includes a memory and a general processing unit, which can include a processor and/or a digital signal processor (DSP) for processing instructions and any data associated with the operation of the system components illustrated in FIG. 2. The components in FIG. 2, as well as functionally analogous arrangements of components, each can require additional hardware and/or software subsystems according to their particular operational requirements. For example, an operating system, persistent data storage subsystem, memory management subsystem, and/or a process scheduler are examples of additional components that can be used in FIG. 3 for hosting the system components in FIG. 2 and its functional analogs for performing the method in FIG. 1.

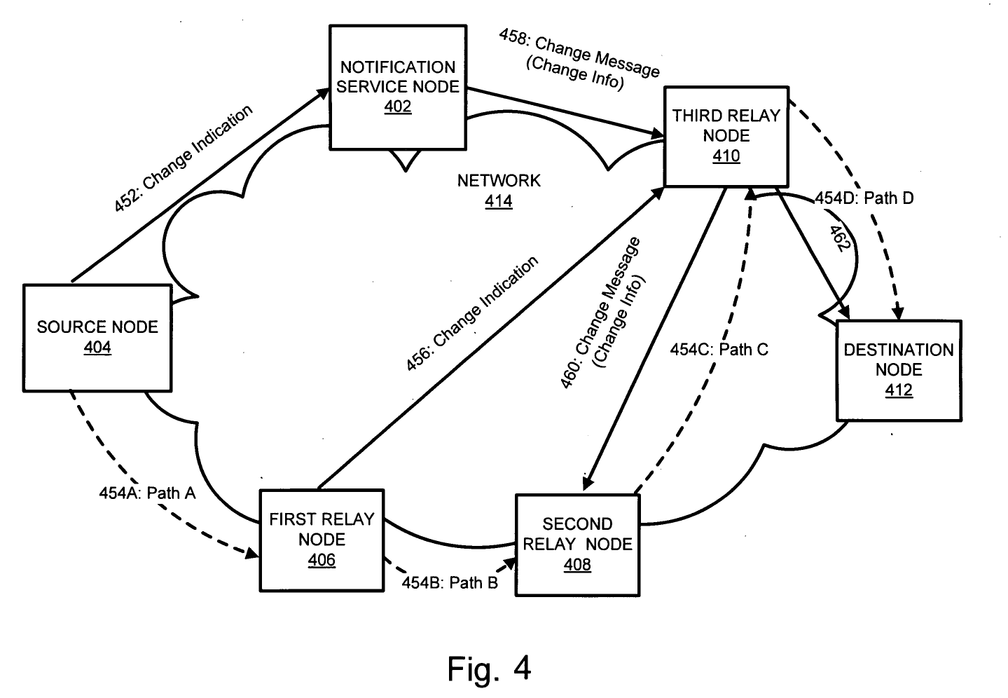

FIG. 4 is a block diagram showing an exemplary arrangement of nodes in a network environment. In this example, the execution environment 302 is hosted by a notification service node 402. Paths A, B, C, and D (454A-D) are each network paths that can be combined into longer network paths such as the network path from the source node 404 through first, second, and third relay nodes 406, 408, & 410 to a destination node 412 for a communication message originating from the source node 404 to the destination node 412. Each path and/or combinations of paths are referred to as a network path 454 herein. The nodes are all part of a network 414, such as a wide area network, a local area network, a personal area network, and the like.

With reference to FIG. 1, in block 152 an indication that presentable content transported via a communication message is changed along a network path traversed by the communication message is received by a network node outside the network path from a node along the network path. Accordingly, a system for reporting a change in presentable content of a communication message includes means for receiving an indication that presentable content transported via a communication message is changed along a network path traversed by the communication message, the indication being received by a network node outside the network path from a node along the network path. For example, as illustrated in FIG. 2, a change detector component 202 is configured to receive an indication that presentable content transported via a communication message is changed along a network path traversed by the communication message.

With reference to FIGS. 2 and 3, the system 200 may be arranged in the notification service 304 and configured to communicate according to a notification protocol provided by a notification protocol layer 306 operatively coupled to a network stack 308. The network stack 308 can be configured to receive a notification via the network 414 by a network interface of the network stack 308. The notification can be provided to a message router component 204 from the network stack 308 via the notification protocol layer 306, as illustrated in FIG. 3. The message router component 204 can be configured to route incoming messages based on any of a variety of attributes accessible via the received message and/or accessible through the executable environment 302 such as an identified sender of the message, a content type of the notification message, and the like. In FIG. 3, the notification service 304, including the message router component 204, can be part of a publish-subscribe service, such as a presence service. For example, the message router component 204 can be configured to receive the change indication as a publish command from a presentity of a principal. The principal can be a component of a message service in the node, the communication message, the sender of the communication message, etc. In the notification service 304, the message router component 204 can be configured to route the received change indication to a change detector component 202, which can be configured to operate as a publication handler.

The notification protocol can be a publish-subscribe protocol, such as a presence protocol, where a publish-subscribe protocol meets the requirements of RFCs 2778 & 2779, with a status element being optional. Alternatively, the notification protocol can include short messaging service (SMS) protocols, multimedia messaging service (MMS) protocols, voice messaging protocols, e-mail protocols, paging systems, instant messaging (IM) protocols, really simple syndication (RSS) protocols, SOAP protocol notifications, and the like. The notification service 304, in performing the method of FIG. 1, can transmit and receive the communication message and the notification message according to a different protocol for each or the same protocol. Exemplary communication message protocols include IM protocols, SMS protocols, MMS protocols, voice messaging protocols, chat protocols, email protocols, and the like.

In the example of FIG. 3, the change detector component 202 can be configured to update a publish-subscribe tuple associated with a publish-subscribe principal of a publish-subscribe presentity that provided the change indication as a publish-subscribe publish command. The associated tuple can be a presence tuple that includes a status value. The principal can be human, software, or hardware, for example and can be one or more of a sender of the communication message, a recipient of the communication message, content of the change message, a location, at least a portion of one of the communication message, a node in the network path, and the network path.

Change indication 452 in FIG. 4 illustrates a change indication received by the notification service node 402 when presentable content of the communication message changes along the network path 454 traversed by the communication message. Any node in the network path 454 can provide a change indication 452 to be received by the change detector component 202. A change in the presentable content of a communication message can be detected and indicated based on addition, deletion, and/or modification of at least a portion of the presentable content of the communication message. For example, a change in the presentable content of an e-mail message occurs when the text of the e-mail message is changed. Similarly, a change in the presentable content of a voicemail message occurs when the audio of the voicemail message is changed. Many more such examples apply. The presentable content change indication can include or identify the changed presentable content or metadata associated with the changed presentable content, such as a location in a message where the content change has occurred, content type information associated with the change, a portion of the message associated with the change, such as an identifiable element of the message, e.g., an element in structured content where the structure is identifiable through a schema or other configuration information. For example, identifiable elements can include sender, recipients, network path nodes, topic/subject, and/or identifiable portions of message content based on a schema and/or MIME type indication. It should be understood that changes to a portion of the communication message that is not presentable content, such as a transmission packet header, routing information, and the like, does not result in a change indication being received. For the purposes of the subject matter described, the deletion of an entire communication message is not intended to be considered a change in the presentable content of the message.

Returning to FIG. 1, in block 154, responsive to the received indication, a change message 458 is generated indicating the change to the presentable content of the communication message. Accordingly, a system for reporting a change in presentable content of a communication message includes means for generating, responsive to the received indication, a change message 458 indicating the change to the presentable content of the communication message. For example, as illustrated in FIGS. 2 and 3, a notification handler component 206 is configured to generate, responsive to the received indication, a change message 458 indicating the change to the presentable content of the communication message.

FIG. 3 illustrates the notification handler component 206 as a component of a publish-subscribe service 304, such as a presence service. In FIG. 3, the change indication 452 can be received by the change detector component 202 as a publish command including tuple information associated with a principal as described above. The change indication 452 can be received as a directed publish command identifying one or more nodes in the network path 454 of the communication message and/or can be received as a publish command for a tuple associated with a subscription list. One or more nodes in the network path 454 of the communication message can send subscribe commands via the network 414 that are received by the message router component 204 via, for example, the network stack 308 and the notification protocol 306. The message router component 204 can be configured to route subscribe commands to a subscription handler 310 of the notification handler component 206 that can be configured to add a principal identified in the received subscribe command to the subscription list associated with the tuple that includes the change information.

When the change indication 452 for the tuple is received, the subscription handler 310 can be invoked to provide for sending notifications including change information to one or more subscribers in the subscription list, as illustrated by the change message 458 with change information sent by the notification service node 402 to the third relay node 410 in FIG. 4. The subscription handler 310 can be invoked responsive to an update to a tuple data store, such as a tuple database 312 illustrated in FIG. 3. The subscription handler 310 can be invoked via notification handler component 206 by the change detector component 202, and/or can be invoked by another component of the notification service 304.

The notification handler component 206 can be invoked via the subscription handler 310 to generate a message, as illustrated by the change message 458, as a publish-subscribe notification. For directed publish commands, the notification handler component 206 can be invoked by the change detector component 202 directly, via the subscription handler 310 as indicated by the change detector component 202, and/or by another component of the publish-subscribe notification service 304.

Continuing with the publish-subscribe exemplary embodiment, the notification handler component 206 illustrated in FIG. 3 can generate the change message 458 as a publish-subscribe notification. The change message 458 indicates a change in the presentable content of the communication message. In the publish-subscribe notification change message 458, the change information can include the updated presentable content for indicating the change to the communication message. In a notification handler component 206 in another type of notification service 304 (other than publish-subscribe), the change message 458 can include information derived from or otherwise based on the change indication 452 received by the change detector component 202. The change information included with the change message 458 can include information from at least a portion of the received change indication 452, which can be transformed, translated, and/or can be otherwise derived based on the received indication 452.

In one aspect, the generated change message 458 includes or identifies an instruction for processing the communication message. For example, the notification handler component 206 can be configured to generate the change message 458 such that the generated change message 458 includes or identifies an instruction for processing the communication message. The instruction can include one of deleting the communication message, routing the communication message, copying at least a portion of the communication message to another network node, converting the communication message to another format, changing the communication message, and the like.

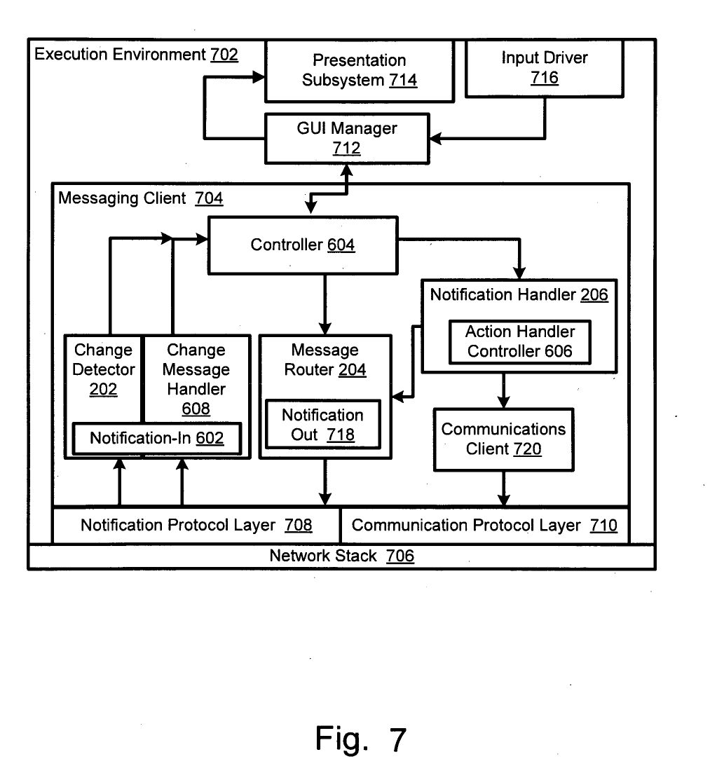

FIG. 7 illustrates an alternative embodiment in which the system 200 is operating in a messaging client 704 in an execution environment 702. In FIG. 7, the notification handler component 206 includes an action handler component 606, the message router component 204 includes a notification out component 718, and the change detector component 202 includes a notification-in component 602.

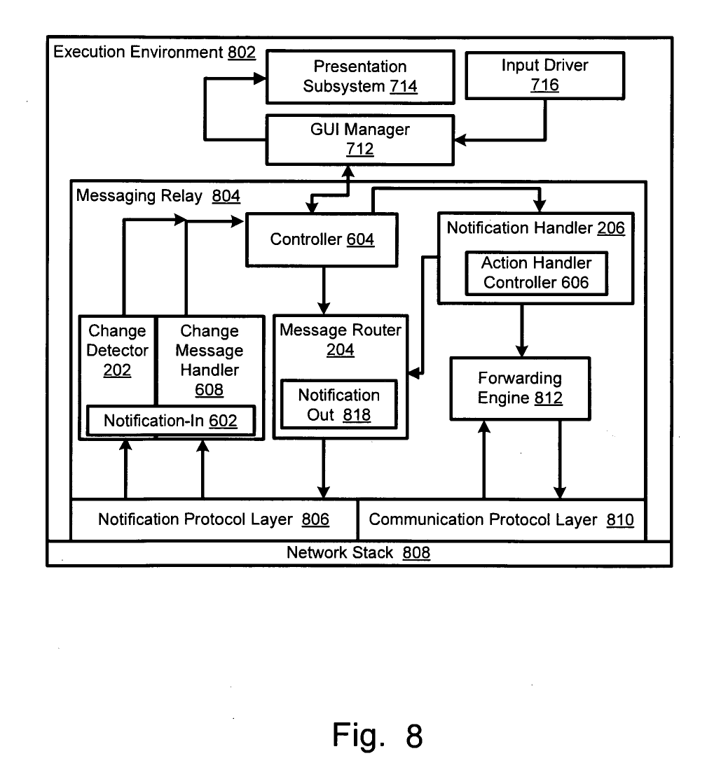

FIG. 8 illustrates an alternative embodiment in which the system 200 is operating in a messaging relay 804 in an execution environment 702. In FIG. 8, the notification handler component 206 includes an action handler component 606, the message router component 204 includes a notification out component 818, and the change detector component 202 includes a notification-in component 602.

In FIGS. 7 and 8, the change indication 456 can be received by the change detector component 202 via the notification-in component 602 and one or more nodes in the network path 454 of the communication message can be identified via source routing and/or routing information accessible to the messaging client 704 and/or the messaging relay 804 as routing information configured in each and/or as source routing information included in the communication message. This routing information can be used to determine nodes in the network path 454. When a change indication 456 is received, a controller component 604 can be invoked to determine an action handler component 606 of notification handler component 206 that is configured to generate a change message 460 that includes change information for sending to one or more nodes in the network path, as illustrated by change message 460 sent by the third relay node 410 to the second relay node 408 in FIG. 4 and illustrated as the alternative or additional change message 462 sent by the third relay node 410 to the destination node 412.

Returning to FIG. 1, in block 156 the generated change message 458 is transmitted separately from the communication message to a node along the network path. Accordingly, a system for reporting a change in presentable content of a communication message includes means for transmitting, separately from the communication message, the generated change message 458 to a node along the network path. For example the message router component 204 is configured to transmit, separately from the communication message, the generated change message 458 to a node along the network path.

In FIG. 3, the notification handler 206 is illustrated operating in the notification service 304. As described above, the notification service 304 can be a publish-subscribe service, such as a presence service. Accordingly, the message router component 204 can be configured to prepare the change message 458 for transmitting via a publish-subscribe protocol. The notification protocol layer 308 can be a publish-subscribe protocol such as a presence protocol. The notification layer 306 can be configured to format the change message 458 according to a notification protocol, such as those discussed above. The message router component 204 can be configured to use a particular notification protocol to use one or more corresponding notification protocol layer 306 components.

In the messaging client 704 and/or messaging relay 804 of FIGS. 7 and 8, the message router component 204, via a notification out component 718 and 818, respectively, can be configured to prepare the change message 460 and/or the change message 462 illustrated in FIG. 4 for transmitting via a notification protocol from the third relay node 410 to the send relay node 410 and/or the destination node 412 via the network 414. The notification protocol layer 308 can be a publish-subscribe protocol such as a presence protocol. The notification protocol layer 708, 808 can be configured to format the change message 460 and/or the change message 462 according to a notification protocol, as described above.

In one aspect, the change message 458 and communication message can be transmitted according to different protocols. For example, the message router component 204 can be configured to transmit the change message 458 and communication message according to different protocols. The change message 458 can be transmitted by the message router component 204 via the notification protocol layer 306 and the network stack 308. The change message 458 can be transmitted according to a publish-subscribe protocol, as described above, even though the communication message is transmitted according to a different protocol. Alternatively, both the communication message and the change message 458 can be transmitted according to the same protocol or according to different protocols where neither is transmitted according to a publish-subscribe protocol.

In another aspect, the change message 458 is a publish-subscribe protocol notification message and change information corresponding to the change message 458 includes a publish-subscribe protocol tuple and identifies a publish-subscribe principal represented by the tuple. For example, the notification handler component 206 can be configured to generate the change message 458 to include change information that includes a publish-subscribe protocol tuple and identifies a principal represented by the tuple and the message router component 204 can be configured to transmit the change message 458 as a publish-subscribe protocol notification message.

In another aspect, the change message 458 is transmitted to a network node along the network path that has not received the communication message yet. For example, the message router component 204 can be configured to transmit the change message 458 to a network node along the network path that has not received the communication message yet. Referring to FIG. 4, the change message 458 can be transmitted to one or more nodes in the network path 454 that has not yet received the message (upstream node), such as the second relay node 408, the third relay node 410 (as illustrated), and/or the destination node 412. The source node 404 and the first relay node 406 have received the communication message and send change indications 452 and 456, respectively, to any of these nodes. Thus, the change message 458 can be sent to one or more of the second relay node 408, the third relay node 410 (as illustrated), and/or the destination node 412 prior to the respective node receiving the communication message. For example, the change message 458 can be provided to the third relay node 410 prior to the third relay node 410 receiving the communication message via path C 454C.

In another aspect, the change message 458 can include information for notifying an upstream node to perform an action, such as informing a user that the communication message is coming, or an action such as sending a message back to a downstream node to reroute, delete, hold, copy, distribute, archive, label, categorize, assign a priority, assign a security level, assign a privacy level, convert the message to different format for delivery, and/or the like. Similarly, the change message 458 can include information for notifying a downstream node to perform an action.

According to another aspect, the indication can include information that the presentable content is changed at a recipient node of the communication message and forwarded in a corresponding communication message and the change message 458 is transmitted to a node sending the communication message. For example, the change detector component 202 can be configured to receive an indication that includes information that the presentable content is changed at a recipient node of the communication message and forwarded in a corresponding communication message and the message router component 204 can be configured to transmit the change message 458 to the node sending the communication message.

In another aspect, the change message 458 and a tuple identifier associated with the change message can be transmitted via a network path including at least one of the destination node 412 and a messaging node for relaying the message, where the destination node 412 and/or the messaging node included in the network path publish information as a change indication, such as change indication 452, associated with the message to the identified tuple.

In another aspect, upon receiving the communication message from another node in the network path, the receiving node can provide a tuple for storing information associated with the communication message, determine an identifier identifying the tuple, and send a notification including the identifier to another node in the network path.

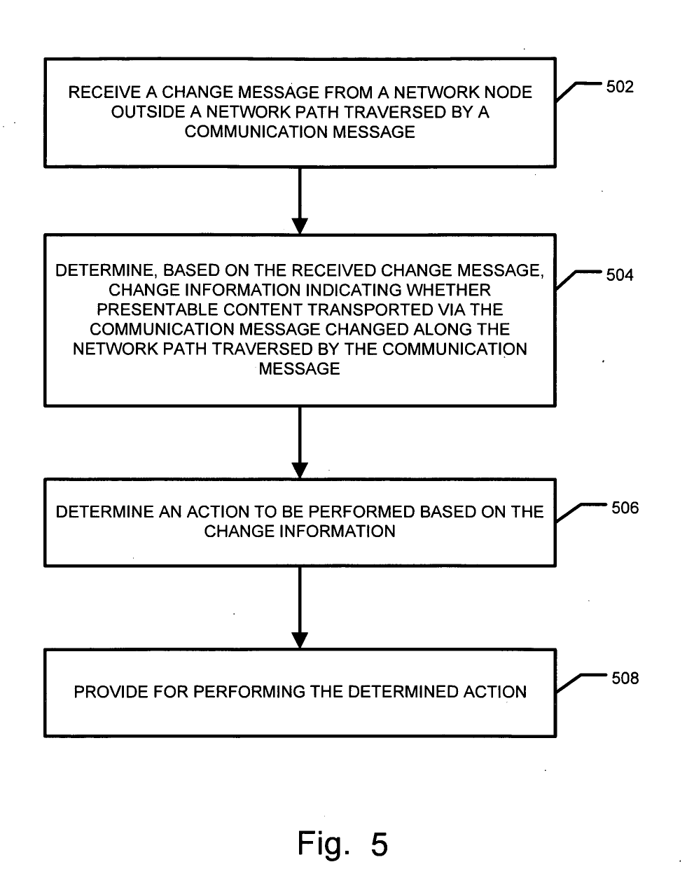

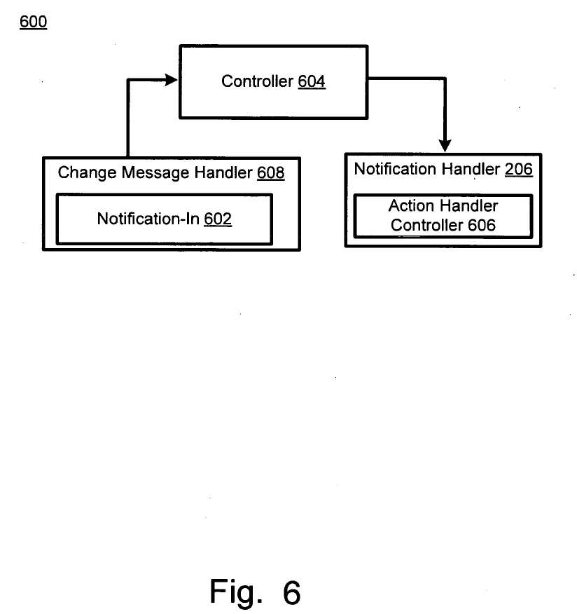

FIG. 5 is a flow diagram illustrating a method for reporting a change in presentable content of a communication message according to an exemplary aspect of the subject matter described herein. FIG. 6 is a block diagram illustrating a system for reporting a change in presentable content of a communication message according to another exemplary aspect of the subject matter described herein. The method illustrated in FIG. 5 can be carried out by, for example, some or all of the components illustrated in the exemplary system of FIG. 6.

With reference to FIG. 5, in block 502 a change message 458 is received from a network node outside a network path traversed by a communication message. Accordingly, a system for reporting a change in presentable content of a communication message includes means for receiving a change message 458 from a network node outside a network path traversed by a communication message. For example, as illustrated in FIG. 6, a change message handler component 608 is configured to receive a change message 458 from a network node outside a network path traversed by a communication message.

In FIG. 6, system 600 illustrates the change message handler component 608, configured to receive a change message, including the notification-in component 602. The change message 458 can be received via a notification protocol, such as the exemplary notification protocols described above. The change message handler component 608 with the notification-in component 602, or an analog, can be operating in any of the nodes 404-412 in the network path 454 traversed by a communication message. The communication message can be transmitted along the network path 454 via a communication protocol associated with one or more of the network paths 454A-D in the network path 454. Exemplary communication protocols are described above.

As described above, in one aspect, the received change message 458 and the communication message can be transmitted according to different protocols. Accordingly, the change message handler component 608 can be configured to receive the change message 458 according to a different protocol than a protocol for transmitting the communication message. For example, the received change message 458 can be a publish-subscribe protocol notification message corresponding to an update of change information that includes a publish-subscribe protocol tuple and identifies a principal represented by the tuple. Additionally, as described above, the received change message 458 can be received by a network node along the network path that has not received the communication message yet.

FIG. 7 illustrates a messaging client 704 in an execution environment 702 and FIG. 8 illustrates a messaging relay 804 in an execution environment 802. The components of FIG. 6 can be adapted to operate in one or both of the execution environments 702 802. In FIG. 7, the components of system 600 of FIG. 6 are shown operating in the message client 704, such as an email client, an IM client, MMS client, SMS client, voice client, publish-subscribe client, and the like.

The source node 404 and/or the destination node 412 in FIG. 4 can, for example, host the messaging client 704 in the execution environment 702 as illustrated in FIG. 7 or an analogous arrangement of components. The first, second, and/or third relay nodes 406, 408, 410 can, for example, host the messaging relay 804 in the execution environment 802 illustrated in FIG. 8 or an analogous arrangement of components.

FIG. 4 illustrates a change message 458 sent via a notification protocol. The change message 458 can be, for example, a notify command defined by a publish-subscribe protocol for updating a tuple associated with a principal where the tuple is maintained by the notification service operating as a publish-subscribe service in the notification service node 402, as described above. The change message 458 can be received by the change message handler component 608 via the notification-in component 602, the network stack 806, and the notification protocol layer 808 operating in the third relay node 410, as illustrated in FIG. 8.

Alternatively, change message 460 and/or the change message 462 in FIG. 4 can be sent by the third relay node 410 and includes change information detected by the first relay node 406 or by a node in the network path that has already received the communication message. FIG. 4 illustrates the change message 460 being sent from the third relay node 410 to the second relay node 408 according to a notification protocol via the network 414, and the change message 462 being sent from the third relay node 410 to the destination node 412 according to a notification protocol via the network 414. A change message can be sent to any node.

The change message 458, 460, 462 can be received via a notification-in component 602 of the change message handler component 608 shown in FIG. 6 operating in the message relay 804 in an execution environment 802, or an analog. For example, the change message can be received via the network stack 808 and the notification protocol layer 806 via an asynchronous notification message associated with a subscription maintained by the notification service 402 and/or the third relay node 410 respectively, an unsolicited asynchronous message, and/or a request/response message, such as a response to a HTTP GET or an HTTP POST.

The change message handler component 608 operating in the messaging relay 804 component illustrated in FIG. 8 can receive the change message via a notification protocol over the network 414 through a network stack 808 and a notification protocol layer 806. The change message 458 illustrates a change message received by a notification-in 602 component operating in an execution environment of the third relay node 710 in the network path 454 of the communication message from the source node 402 to the destination node 412. Communication messages can be received by the messaging relay 804 via the network 414 through the network stack 806 interoperating with a communication protocol layer 810. A forwarding engine 812 can be configured to send and receive a communications message to transmit the communication message along the network path 454 through interoperation with the communication protocol layer 810.

In another aspect, the change message handler component 608 can be adapted for operation in the execution environment 702 as illustrated in FIG. 7. The notification-in component 602 of the change message handler component 608 can receive the change message 458 via a notification protocol and the network 414 through a network stack 706 and a notification protocol layer 708. For example, the change message can be received by the messaging client 704 operating in the execution environment 702 hosted by the destination node 412. Communication messages can be received by the messaging client 704 via the network 414 through the network stack 706 interoperating with a communication protocol layer 710. A communications client 720 can be configured to send and receive communications messages through interoperation with the communication protocol layer 710 and the controller component 604, which can, together with GUI manager 712, presentation subsystem 714, and input driver 716, provide an interface to a user or another machine.

Returning to FIG. 5, in block 504 change information is determined based on the received change message 458. The change information indicates whether presentable content transported via the communication message changed along the network path traversed by the communication message. Accordingly, a system for reporting a change in presentable content of a communication message includes means for determining, based on the received change message 458, change information indicating whether presentable content transported via the communication message changed along the network path traversed by the communication message. For example, as illustrated in FIG. 4, a change message handler component 608 is configured to determine, based on the received change message 458, change information indicating whether presentable content transported via the communication message changed along the network path traversed by the communication message.

The received change message 458, 460, 462 can be processed by the change message handler component 608 at the receiving node to extract change information for indicating whether presentable content transported via the communication message changed along the network path traversed by the communication message.

In one aspect, the received change message 458 includes or identifies an instruction for processing the communication message, as described above. For example, the change message handler component 608 can be configured to determine, from the received change message 458, change information that includes or identifies an instruction for processing the communication message, such as deleting the communication message, routing the communication message, copying at least a portion of the communication message to another network node, converting the communication message to another format, and changing the communication message.

In another aspect, the change information can indicate that the presentable content is changed at a recipient node of the communication message and forwarded in a corresponding communication message and the change message 458 is received at a node sending the communication message. For example, the change message handler component 608 can be configured to determine that the change information indicates that the presentable content is changed at a recipient node of the communication message and forwarded in a corresponding communication message and the change message 458 is received at a node sending the communication message.

Returning to FIG. 5, in block 506 an action to be performed is determined based on the change information. Accordingly, a system for reporting a change in presentable content of a communication message includes means for determining an action to be performed based on the change information. For example, as illustrated in FIG. 6, a controller component 604 is configured to determine an action to be performed based on the change information.

Based on the change information in the change message 458, 460, 462 an action to be performed can be determined. For example, with reference to FIG. 7, a table lookup can be by the controller component 604 of a table stored in a local memory (not shown) of the execution environment 702, or remotely stored, to determine which action to perform based on the change information.

In another aspect, an action to be performed can be determined by presenting the determined change information via a user interface and receiving user input identifying the action to be performed. For example, the controller component 604 can be configured to determine an action to be performed by presenting a representation of the change information via a user interface and receiving user input identifying the action to be performed, as discussed below. FIG. 6 illustrates a controller component 604 configured to present a representation of the change information via an interface to, for example a user, an other component operating in an execution environment with the controller component 604, and/or a remote component operating in another execution environment than the controller component 604. FIG. 7 illustrates a controller component 604 adapted for operating in the messaging client 704 as hosted by, for example, the source node 402 and/or the destination node 412. The controller component 604 as illustrated is operatively coupled to a GUI manager 712. The GUI manager can be configured to present the representation of the change information to a user via a presentation subsystem 714 configured to control one or more output devices, such as a display or speaker.

FIG. 8 illustrates a controller component 604 adapted for operating in the messaging relay 804 as hosted by, for example, the second relay node 408. The controller component 604 as illustrated is operatively coupled to one or more action handler components 606. The controller component 604 can be configured to, together with GUI manager 712, presentation subsystem 714, and input driver 716, provide an interface to a user or another machine to present the representation of the change information to a local and/or remote component as illustrated by an action handler component 606 of the notification handler 206. The notification out 818 can also receive a presentation of the change information for transmission to another presentation mechanism. Alternatively, the messaging relay 804 may serve as a message forwarding node, using forwarding engine 812, and may omit GUI manager 712, presentation subsystem 714, and input driver 716.

The controller component 604 can be configured to receive an action indicator in response to presenting the change information. An action indicator can be received in a variety of ways, including receiving an input via an input device interoperating with an input driver 716 as illustrated in FIG. 7. The input can be provided by the input driver 716 to the GUI manager 712 for receiving and routing to a component associated with the input. When the input is received in correspondence with the presentation of the change information, the input can be routed to the controller component 604.

Returning to FIG. 5, in block 508, performing the determined action is provided for. Accordingly, a system for reporting a change in presentable content of a communication message includes means for providing for performing the determined action. For example, as illustrated in FIG. 4, an action handler component 606 is configured to provide for performing the determined action.

The controller component 604 can be configured to invoke one or more action handler components 606. An action handler component 606 can operate within the same execution environment 702, 802 as a controller component 604 and/or can operate in another execution environment. An action handler component 606 can be configured to interact with any accessible communication client, such as notification out component 818 of message router component 204, communication client 720, forwarding engine 812, an application layer protocol such as a notification protocol layer 806 and/or a communication protocol layer 810, and/or any layer of a network stack 808.

In one aspect, the action includes one of deleting the communication message, routing the communication message, copying at least a portion of the communication message to another network node, converting the communication message to another format, and changing the communication message. For example, the action handler component 606 can be configured to provide for performing an action that includes one of deleting the communication message, routing the communication message, copying at least a portion of the communication message to another network node, converting the communication message to another format, and changing the communication message.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for reporting a change in presentable content of a communication message, the method comprising:
receiving an indication that presentable content transported via a communication message is changed along a network path traversed by the communication message, the indication being received by a network node outside the network path from a node along the network path;
generating, responsive to the received indication, a change message indicating the change to the presentable content of the communication message; and
transmitting, separately from the communication message, the generated change message to a node along the network path;
wherein at least one of the preceding actions is performed on at least one electronic hardware component.

2. The method of claim 1 wherein the generated change message includes or identifies an instruction for processing the communication message.

3. The method of claim 2 wherein the instruction includes one of deleting the communication message, routing the communication message, copying at least a portion of the communication message to another network node, converting the communication message to another format, and changing the communication message.

4. The method of claim 1 wherein the change message and communication message are transmitted according to different protocols.

5. The method of claim 1 wherein the change message is a publish-subscribe protocol notification message and change information corresponding to the change message includes a publish-subscribe protocol tuple and identifies a principal represented by the tuple.

6. The method of claim 1 wherein the change message is transmitted to a network node along the network path that has not received the communication message yet.

7. The method of claim 1 wherein the indication includes information that the presentable content is changed at a recipient node of the communication message and forwarded in a corresponding communication message and the change message is transmitted to a node sending the communication message.

8. A method for reporting a change in presentable content of a communication message, the method comprising:
receiving a change message from a network node outside a network path traversed by a communication message;
determining, based on the received change message, change information indicating whether presentable content transported via the communication message changed along the network path traversed by the communication message;
determining an action to be performed based on the change information; and
providing for performing the determined action;
wherein at least one of the proceeding actions is performed on at least one electronic hardware component.

9. The method of claim 8 wherein the received change message includes or identifies an instruction for processing the communication message.

10. The method of claim 9 wherein the instruction includes one of deleting the communication message, routing the communication message, copying at least a portion of the communication message to another network node, converting the communication message to another format, and changing the communication message.

11. The method of claim 8 wherein the received change message and the communication message are transmitted according to different protocols

12. The method of claim 8 wherein the received change message is a publish-subscribe protocol notification message corresponding to an update of change information that includes a publish-subscribe protocol tuple and identifies a principal represented by the tuple.

13. The method of claim 8 wherein the received change message is received by a network node along the network path that has not received the communication message yet.

14. The method of claim 8 wherein the change information indicates that the presentable content is changed at a recipient node of the communication message and forwarded in a corresponding communication message and the change message is received at a node sending the communication message.

15. The method of claim 8 wherein the action includes one of deleting the communication message, routing the communication message, copying at least a portion of the communication message to another network node, converting the communication message to another format, and changing the communication message.

16. The method of claim 8 wherein determining an action to be performed includes presenting the determined change information via a user interface and receiving user input identifying the action to be performed.

17. A system for reporting a change in presentable content of a communication message, the system comprising:
means for receiving an indication that presentable content transported via a communication message is changed along a network path traversed by the communication message, the indication being received by a network node outside the network path from a node along the network path;
means for generating, responsive to the received indication, a change message indicating the change to the presentable content of the communication message; and
means for transmitting, separately from the communication message, the generated change message to a node along the network path
wherein at least one of the means includes at least one electronic hardware component.

18. A system for reporting a change in presentable content of a communication message, the system comprising system components including:
a change detector component configured to receive an indication that presentable content transported via a communication message is changed along a network path traversed by the communication message, the indication being received by a network node outside the network path from a node along the network path;
a notification handler component configured to generate, responsive to the received indication, a change message indicating the change to the presentable content of the communication message; and
a message router component configured to transmit, separately from the communication message, the generated change message to a node along the network path
wherein at least one of the system components includes at least one electronic hardware component.

19. The system of claim 18 wherein the notification handler component is configured to generate the change message such that the generated change message includes or identifies an instruction for processing the communication message.

20. The system of claim 19 wherein the instruction includes one of deleting the communication message, routing the communication message, copying at least a portion of the communication message to another network node, converting the communication message to another format, and changing the communication message.

21. The system of claim 18 wherein the message router component is configured to transmit the change message and communication message according to different protocols.

22. The system of claim 18 wherein:
the notification handler component is configured to generate the change message to include change information that includes a publish-subscribe protocol tuple and identifies a principal represented by the tuple message; and
the message router component is configured to transmit the change message as a publish-subscribe protocol notification message.

23. The system of claim 18 wherein the message router component is configured to transmit the change message to a network node along the network path that has not received the communication message yet.

24. The system of claim 18 wherein the change detector component is configured to receive an indication that includes information that the presentable content is changed at a recipient node of the communication message and forwarded in a corresponding communication message and the message router component is configured to transmit the change message to a node sending the communication message.

25. A system for reporting a change in presentable content of a communication message, the system comprising:
means for receiving a change message from a network node outside a network path traversed by a communication message;
means for determining, based on the received change message, change information indicating whether presentable content transported via the communication message changed along the network path traversed by the communication message; and
means for determining an action to be performed based on the change information;
wherein at least one of the means includes at least one electronic hardware component.

26. A system for reporting a change in presentable content of a communication message, the system comprising system components including:
a change message handler component configured to receive a change message from a network node outside a network path traversed by a communication message, and to determine, based on the received change message, change information indicating whether presentable content transported via the communication message changed along the network path traversed by the communication message;
a controller component configured to determine an action to be performed based on the change information; and
an action handler component configured to provide for performing the determined action;
wherein at least one of the system components includes at least one electronic hardware component.

27. The system of claim 26 wherein the change message handler component is configured to determine, from the received change message, change information that includes or identifies an instruction for processing the communication message.

28. The system of claim 27 wherein the instruction includes one of deleting the communication message, routing the communication message, copying at least a portion of the communication message to another network node, converting the communication message to another format, and changing the communication message.

29. The system of claim 26 wherein the change message handler component is configured to receive the change message according to a different protocol than a protocol for transmitting the communication message.

30. The system of claim 26 wherein change message handler component is configured to receive the change message as a publish-subscribe protocol notification message corresponding to an update of change information that includes a publish-subscribe protocol tuple and identifies a principal represented by the tuple.

31. The system of claim 26 wherein the received change message is received by a network node along the network path that has not received the communication message yet.

32. The system of claim 26 wherein the change message handler component is configured to determine that the change information indicates that the presentable content is changed at a recipient node of the communication message and forwarded in a corresponding communication message and the change message is received at a node sending the communication message.

33. The system of claim 26 wherein the action handler component is configured to provide for performing an action that includes one of deleting the communication message, routing the communication message, copying at least a portion of the communication message to another network node, converting the communication message to another format, and changing the communication message.

34. The system of claim 26 wherein the controller component is configured to determine an action to be performed by presenting the determined change information via a user interface and receiving user input identifying the action to be performed.

35. A computer readable medium storing a computer program, executable by a machine, for reporting a change in presentable content of a communication message, the computer program comprising executable instructions for:
receiving an indication that presentable content transported via a communication message is changed along a network path traversed by the communication message, the indication being received by a network node outside the network path from a node along the network path;
generating, responsive to the received indication, a change message indicating the change to the presentable content of the communication message; and
transmitting, separately from the communication message, the generated change message to a node along the network path.

36. A computer readable medium storing a computer program, executable by a machine, for reporting a change in presentable content of a communication message, the computer program comprising executable instructions for:
receiving a change message from a network node outside a network path traversed by a communication message;
determining, based on the received change message, change information indicating whether presentable content transported via the communication message changed along the network path traversed by the communication message;
determining an action to be performed based on the change information; and
providing for performing the determined action.
